(19) United States
(12) Patent Application Publication
(10) Pub. No.: US 2006/0230168 A1
(43) Pub. Date: Oct. 12, 2006

(54) Method and system for establishing ad-hoc session in push-to-talk over cellular network

(75) Inventors: Sang-Kyung Sung, Suwon-si (KR); Joon-Goo Park, Yongin-si (KR); Sung-Jin Park, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/386,507

(22) Filed: Mar. 22, 2006

(30) Foreign Application Priority Data
Mar. 23, 2005 (KR) 2005-24243

(51) Int. Cl. G06F 15/16

(52) U.S. Cl. 709/230

(57) ABSTRACT

A method is provided to establish an ad-hoc PoC group session by causing a PoC client with a pre-established session to use an existing session as a conference server for a group PoC call and by including many individuals and members of at least one PoC group among talk targets. In the method, a session invitation proxy message, which includes session dialog information, entry uniform resource identifiers (URIs), and a Session Initiation Protocol (SIP) message method, is transmitted to an originating PoC server in a state in which the pre-established session is established. The originating PoC server transmits the message based on the SIP message method to a destination address included in the session invitation proxy message. Finally, the ad-hoc session is established between an originating PoC system and the destination address included in the session invitation proxy message.

### CLAIM OF PRIORITY

This application claims the benefit under 35 U.S.C. §119(a) from an application entitled “METHOD AND SYSTEM FOR ESTABLISHING AD-HOC SESSION IN PUSH-TO-TALK OVER CELLULAR NETWORK” filed in the Korean Intellectual Property Office on Mar. 23, 2005 and assigned Serial No. 2005-24243, the contents of which are incorporated herein by reference.

### BACKGROUND OF THE INVENTION

1. Field of the Invention

The present invention relates to technology for establishing a session for push-to-talk-over-cellular (PoC) group talk service, and more particularly, to a method for establishing an ad-hoc PoC group talk with expanded, flexible session request targets.

2. Description of the Related Art

Significant developments in mobile communications technology and extension of mobile communications networks have resulted in the development of a vast array of services and applications for use with a cellular phone. At the same time, demand among cellular phone users for these additional services, such as a location, a multimedia and a push-to-talk (PTT) service, is increasing. The PTT service supports various supplementary functions such as an instant messenger function and a status display function, as well as a group call and a voice call which are also provided by an existing radio or a trunk radio system (TRS).

Currently, standardization of a push-to-talk-over-cellular (PoC) service that employs the PTT function in a mobile communication network is taking place. A unique feature of the PoC service is that a user can participate in a plurality of PoC sessions and can also use a call service while switching from the PoC sessions as desired. This feature is a requirement that is specified in the open mobile alliance (OMA), which is a forum for specifying mobile communications services.

FIG. 1 is a schematic diagram of a conventional PoC service system. Referring to FIG. 1, a PoC client 10, as a service requester installed in a mobile station, is generally connected to a Session Initiation Protocol/Internet Protocol (SIP/IP) core 30 that supports SIP and IP multimedia via an access network 20.

The PoC client 10 resides in a PoC user terminal to provide access to the PoC service. The PoC client 10 mainly serves to establish, participate in and terminate a PoC session. In addition, the PoC client 10 makes and transmits a talk burst, supports an instant personal alert and performs authentication when accessing the PoC service. Hereinafter, unless otherwise stated, the PoC client 10 is assumed to be the same as a PoC service subscriber or PoC terminal.

The SIP/IP core 30 is connected to a PoC server 60, a Group List and Management System (GLMS) 50, and a presence server 70 in order to support the PoC service.

Generally, SIP is a standard defined in Internet Engineering Task Force (IETF) Request for Comments (RFC) 2543. SIP is an application-layer control protocol that is used to set up, modify and terminate a session or call for multimedia communication such as video and voice communication. SIP exists over a User Datagram Protocol (UDP)/TCP/IP layer, which supports both unicast and multicast sessions so as to initiate a session by inviting participants to a multimedia conference with a client/server protocol capable of exchanging SIP Request and Response messages in a request/response fashion.

The SIP Request message provides six functions in RFC 2543 as follows: INVITE (Invitation to participate in a session), ACK (Acceptance of an INVITE request), BYE (Termination of a call), REGISTER (Registration with the database of a redirect server by a user agent), CANCEL (Cancellation of a pending request), and OPTIONS. The SIP Response message provides status codes as follows: 1xx (Information response), 2xx (Successful response), 3xx (Redirection response), 4xx (Client Error, Request Failure), 5xx (Server Error), and 6xx (Global Failure).

At this time, the PoC server 60 has a Controlling PoC Function for maintaining and managing a PoC session, or a Participating PoC Function for participating in a PoC session for a one-to-one PoC call or a one-to-two or more PoC call (or group PoC call).

The PoC server performs both a Controlling PoC Function of controlling overall maintenance and management of a PoC session, and the Participating PoC Function of controlling maintenance and management between each PoC session, which will be explained below with reference to Tables 1 and 2.

TABLE 1
Controlling PoC Function (CF)

Provides centralized PoC session handling
Provides centralized Media distribution
Provides centralized Talk Burst Arbitration functionality including talker
identification
Provides SIP session handling, such as SIP session origination,
termination, etc.
Provides policy enforcement for participation in group sessions
Provides participant information
Collects and provides centralized media quality information
Provides centralized charging reports
May provide transcoding between different codecs
Supports Talk Burst Control Protocol Negotiation

As shown in Table 1, the PoC server performing the CF (or the Controlling PoC server) serves to maintain and manage a PoC session. In particular, the Controlling PoC server receives requests for the floor from PoC clients, arranges an order in which to give the clients the floor, and gives the clients the floor in that order. The Controlling PoC server also distributes a talk burst, for which an arbitrary PoC client makes a request, to all other PoC clients participating in a group PoC call, and provides information of the PoC clients participating in the group PoC call.

As shown in Table 2 below, the PoC server performing the PF (or the Participating PoC server) manages a PoC session between the Controlling PoC server and each PoC client. Particularly, the Participating PoC server relays the floor between the PoC client and the Controlling PoC server when the PoC client makes a request for the floor or when the Controlling PoC server gives the floor to the PoC client. In addition, the Participating PoC server relays media between the Controlling PoC server and the PoC client, performs transcoding between different codecs, and filters one of two concurrent PoC sessions according to the choice of a PoC user when there is simultaneous talking in the two concurrent PoC sessions.

TABLE 2
Participating PoC Function (PF)

Provides PoC session handling
May provide the Media relay function between PoC client and Controlling
PoC server
May provide user media adaptation procedures
May provide the Talk Burst control message relay function between PoC
client and Controlling PoC server
Provides SIP session handling, such as SIP session origination,
termination, etc., on behalf of the represented PoC client.
Provides policy enforcement for incoming PoC session (e.g. access
control, incoming PoC session barring, availability status, etc.)
May collect and provide media quality information
Provides participant charging reports
May provide filtering of media streams in the case of simultaneous
sessions
May provide transcoding between different codecs
May support Talk Burst Control Protocol Negotiation
Stores the current Answer Mode and Incoming PoC Session Barring
preferences of the PoC client

In the PoC service system described above, the PoC user can input information on groups and their members into the GLMS 50 through the PoC user's terminal, and can receive information about other PoC users with whom the PoC user can talk through an individual or group list transmitted from the GLMS 50. Alternatively, in order to create, modify and manage groups and their members, the information on the groups and their members may be input into the GLMS 50 via a communication network, such as the Internet or Intranet.

In order to use the PoC call service, the PoC user registers his/her PoC address with the SIP/IP core 30. The SIP/IP core 30 stores information on the PoC user by request of the PoC user. Thus, when another PoC user tries to request the group PoC call, the PoC user registers his/her information with the SIP/IP core 30 in advance, and requests the group PoC call to his/her SIP/IP core 30 by using group identification information transmitted from the GLMS 50.

The SIP/IP core performs addressing and domain locating by using information of the requesting PoC user, and then transmits a PoC call request to a home PoC server with which the requesting PoC user is registered. In regard to the PoC call request, the PoC server prepares to establish a PoC session, obtains each user's information from the GLMS, and then transmits a PoC call request signal to the SIP/IP core. When a PoC call request is made to users within an Intradomain, the PoC server performs both the CF and the PF. The PoC server managing the call-requested PoC user requests the PoC call to the PoC user after locating the SIP/IP core by use of the PoC user's information transmitted to the PoC server.

In order to describe in detail a session connection with the PoC client(s) in the PoC session, features of the Open Mobile Alliance (OMA) PoC system will be described below. The features of the OMA PoC system according to setup of originating and terminating PoC sessions are as follows.

The PoC system is divided into two modes, an on-demand session mode and a pre-established (or early) session mode, according to whether the connection with a PoC server within a user's home network is established.

The pre-established session mode is designed so that the PoC user establishes a session between a PoC client and a PoC server belonging to a PoC user's home network in advance by request of the PoC user. The pre-established session is necessary to enable the PoC user to pre-negotiate media parameters to be used with the PoC server and perform rapid session establishment without renegotiating the media parameters to be used in the future between the PoC server and client. In order to establish the pre-established session, the PoC client provides supported media parameters to a Session Description Protocol Multipurpose Internet Mail Extensions (SDP MIME) body through a method of SIP INVITE, and responds to the media parameters provided from the PoC server. The PoC client sends, to the PoC user, identification information of the pre-established session that is newly established for a response message received from the PoC server, together with a conference Uniform Resource Identifier (URI). When using the pre-established session, it is possible to pre-negotiate such parameters as an IP address, a port number, a codec to be used, and a talk burst control protocol.

The on-demand session mode refers to a state in which the PoC user does not establish the pre-established session, and means that the PoC user performs a PoC session connection procedure after receiving an INVITE message from another PoC user.

Hereinafter, a process of establishing a PoC multimedia session of the PoC system will be described with distinction of the originating side and the terminating side.

First, the session establishment process performed on the originating side will be described with reference to FIG. 2.

Referring to FIG. 2, a PoC client A sends an INVITE request message (S11), which includes the SIP address of a recipient to whom the PoC client A desires to talk, to an SIP/IP core A. At this time, the INVITE request message includes information elements such as a PoC address of the call-requesting client, requested media parameters (because the requested session is based on the multimedia, having various media attribute values such as an audio and video encoding method, a rate, a payload type etc.), and an attribute value informing PoC service, and is forwarded to a PF A (i.e. a Participating PoC server A) via corresponding servers (Proxy Call Session Control Function (P-CSCF) and Serving Call Session Control Function (S-CSCF) in an IP Multimedia Subsystem (IMS) network through a route query at a Dynamic Host Configuration Protocol (DHCP) server or DNS server (S12). Since the PF A, to which a PoC user is connected when a general call request is made, can be implemented as an entity different from a CF X (i.e. Controlling PoC server X) that manages the talk burst of an established session, the INVITE request message forwarded through steps S11 and S12 is transmitted to the CF X via an SIP/IP core of each network (S13, S14 and S15).

A Controlling network X including the CF X transmits the INVITE request message forwarded through step S15 to the corresponding SIP/IP core, and then receives a response message. An SIP response message with which the terminating side network responds may be a provisional response message of 1XX, a successful response message of 2XX, and an error response message of 4XX, 5XX or 6XX. Herein, the description will be oriented to a normal call processing procedure within the range of the fundamental effect of the present invention. After step S15, the CF X can receive an AUTO-ANSWER or OK response according to an answering mode of the terminating side. Alternatively, in the case of the AUTO-ANSWER response of FIG. 2, the CF X may receive an SIP 183 Session Progress signal (S16), and thus perform connection between the PoC server and client in the IMS network of the call requester. The call acceptance signal of a recipient is the SIP 183 Session Process or SIP 200 OK response and is forwarded to the PoC client A via the CF and PF, the PoC servers (S16 through S20).

Meanwhile, after receiving the 200 OK or 183 Session Progress response (S16) from the PoC server of the terminating side, the CF determines that a PoC call is connected and then sends a Floor Granted signal (S21), which gives the floor to the PoC client A for a talk burst. Granting of talk burst authority according to the response (200 OK or 183 Session Progress) can be divided into confirmed and unconfirmed types, which is why the CF requires a buffering function.

After receiving the response signal to the INVITE request signal (S16 through S20), the PoC client A receives the Floor Granted signal in order to forward a talk burst transmission enable signal (i.e. a ring back tone) using a Real-time Transport Protocol (RTP) Control Protocol (RTCP) (S21 and S22). At this time, the Floor Granted signal (S21) is generated from the CF having a right to arbitrate the talk burst, and transmitted to the corresponding PoC client via the PF, which manages the corresponding PoC client. The Floor Granted signal can be transmitted without passing through the SIP/IP core because of the use of a bearer's route rather than the SIP. Finally, the PoC user who confirms the ring back tone transmits a media stream (e.g. voice) using an RTP (S23 and S24).

FIG. 3 shows flow of signals in a conventional process of establishing a terminating PoC multimedia session. In this case, an originating PoC call requester requests call processing by sending a multimedia invitation message using a SIP (the present invention illustrates a case of requesting audio and video calls), and a pre-established session exists with an auto answer mode set on a terminating side. That is, the process is directed to a terminating side procedure assuming successful session establishment when the pre-established session is established between terminating PoC server and client. At this time, media attribute values between the PoC server and client that set the pre-established session use designated attribute values without change when a new session is requested.

Referring to FIG. 3, an INVITE request message received from an originating side network is transmitted to a PoC server belonging to the home network of a terminating PoC client through an SIP/IP core according to the call processing procedure of an IMS network (S31, S32 and S33). At this time, a PF B sets a setup value of its answering mode to an auto answer mode, and thus transmits a SIP 200 OK message to the originating side network in response to the INVITE request message (S34, S35 and S36). The PF B does not transmit the INVITE request message to the PoC client that is connected therewith because it is unnecessary to change the pre-established session.

Meanwhile, the PoC server, CF X, of a controlling network which receives the OK response returned through an IMS route transmits the OK response (S37) to the originating PoC client, thereby completing the PoC call processing procedure, and transmits a Floor Granted signal (S38), which gives the floor for a talk burst to the originating PoC client. Further, the CF transmits an RTCP signal granting the floor and simultaneously transmits a Sending Talk Burst signal including a PoC address or display name of the PoC user having the floor, to a terminating PoC user (S39 and S40). Thereby, the CF enables a terminating PoC client to receive beforehand sender's information of a media stream to be transmitted later. This talk burst transmission signal can be transmitted without passing through the SIP/IP core network because of the use of the bearer's route rather than the SIP, as in FIG. 2. Finally, the media stream including audio and video sent from the originating side is transmitted to a PoC client B through the bearer's route using the RTP. Hence, the PoC call is initiated (S50).

Meanwhile, the PoC system has a multilateral conference function, a representative function of OMA PoC Release 1, of a half-duplex communication mode, in addition to the above-mentioned call processing procedure. The PoC conference is divided into an ad-hoc PoC group, a pre-arranged PoC group, and a chat PoC group according to the attribute of a participating group.

Group PoC calls of the ad-hoc and pre-arranged PoC groups are characterized by dial-out session establishment, requested to a conference server, and forwarding the session establishment request from a server (conference server) acting as a focus to each client of interest.

The chat PoC group is characterized by dial-in session establishment with respect to a conference server because each client is previously aware of information of the session of interest.

However, the conventional PoC system fails to designate a more dynamic group PoC call or flexible talk group because of a restriction depending on the group attribute when the PoC client for the PoC call is set upon establishing the session.

For example, when the originating PoC user draws up a recipient list in order to make an ad-hoc PoC group talk, the conventional PoC system does not support a function of establishing a group identity of the pre-arranged PoC group as a member in the ad-hoc group list. In this case, the PoC user trying out the ad-hoc PoC group talk should obtain information on the corresponding member of the group using uniform resource identifier (URI) information for identifying the pre-arranged PoC group and then add the corresponding member of the ad-hoc PoC group to be newly established. Hence, the PoC user is overburdened. (It is generally assumed that the PoC user does not store an URI list of all participants of the pre-arranged PoC group in his/her terminal)

Meanwhile, unlike the foregoing method, a method of forwarding an additional SIP message during the session to perform dial-in on the ad-hoc PoC group session after establishing the group PoC call of the ad-hoc PoC group including other PoC users except the pre-arranged PoC group to be included can be taken into consideration. This method also has the drawbacks of duplicating the session request, and the presence of two focuses when a server hosting the pre-arranged group is not an ad-hoc session server.

### SUMMARY OF THE INVENTION

It is an object of the present invention to provide a method for establishing an ad-hoc PoC group session by including many individuals and at least one PoC group among talk targets when a PoC client establishes the ad-hoc PoC group session for a group PoC call using a pre-established session or an on-demand session.

According to the present invention, there is provided a system for establishing an ad-hoc session in a push-to-talk-over-cellular (PoC) network, including an originating PoC system in which an originating PoC client transmits a session invitation proxy message, which includes session dialog information, entry uniform resource identifiers (URIs), and a Session Initiation Protocol (SIP) message method, to an originating PoC server in which a pre-established or on-demand session is arranged between the originating PoC client and the originating PoC server, arbitrary individual PoC clients with which the originating PoC server intends to establish the ad-hoc session, and an arbitrary PoC group system with which the originating PoC server intends to establish the ad-hoc session.

According to the present invention, there is provided a system for establishing an ad-hoc session in a push-to-talk-over-cellular (PoC) network, including an originating PoC system in which an originating PoC client transmits a session invitation proxy message, which includes session dialog information, entry uniform resource identifiers (URIs), and a Session Initiation Protocol (SIP) message method, to an originating PoC server after session establishment using a session establishment request message exchanged between the originating PoC client and the originating PoC server, arbitrary individual PoC clients with which the originating PoC server intends to establish the ad-hoc session, and an arbitrary PoC group system with which the originating PoC server intends to establish the ad-hoc session.

According to the present invention, there is provided a method for establishing an ad-hoc session using a pre-established session in a push-to-talk-over-cellular (PoC) network, including transmitting a session invitation proxy message, which includes session dialog information, entry uniform resource identifiers (URIs), and a Session Initiation Protocol (SIP) message method, to an originating PoC server in a state in which the pre-established session is established, transmitting, by the originating PoC server, the message based on the SIP message method to a destination address included in the session invitation proxy message, and establishing the ad-hoc session between an originating PoC system and the destination address included in the session invitation proxy message.

According to the present invention, there is provided a method for establishing an ad-hoc session in a push-to-talk-over-cellular (PoC) network, including performing session establishment between a server hosting the session and a client intending to establish the ad-hoc session, transmitting a session request message with reference to session dialog information, entry uniform resource identifiers (URIs), and a Session Initiation Protocol (SIP) message method which are arranged in the step of performing session establishment, and establishing the ad-hoc session between an originating PoC system and the destination address included in the session request message.

According to the present invention, there is provided a push-to-talk-over-cellular (PoC) client for establishing an ad-hoc session in a PoC network, wherein, when a pre-established session is established, a session invitation proxy message including session dialog information, entry uniform resource identifiers (URIs), and a Session Initiation Protocol (SIP) message method is transmitted to an originating PoC server, a session request message is directly transmitted to an individual PoC user among entries of the entry URIs included in the session invitation proxy message, and a message, which includes a destination group identity, the SIP message method, an identity of a server hosting the session and an indication informing whether or not to act as a host of a conference, is transmitted to a PoC group among the entries of the entry URIs.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a schematic diagram of a conventional PoC service system;

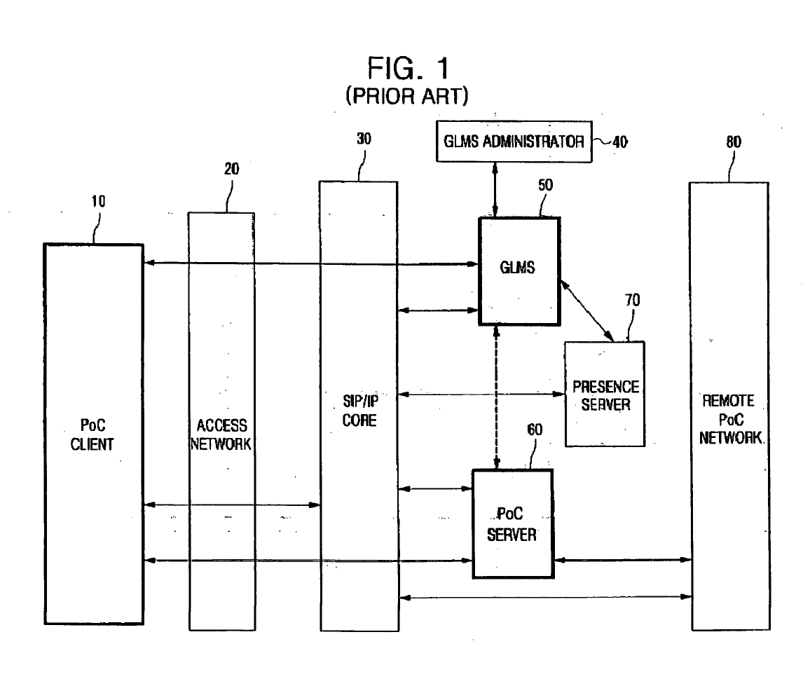

FIG. 2 shows flow of signals in a conventional process of connecting an originating PoC multimedia session;

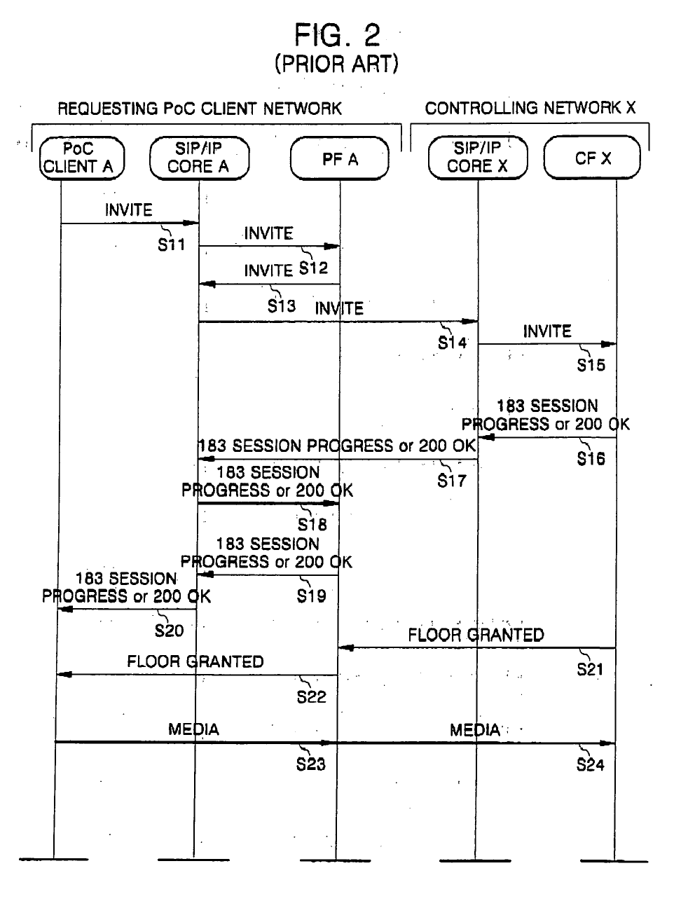

FIG. 3 shows a flow of signals in a conventional process of connecting a terminating PoC media session;

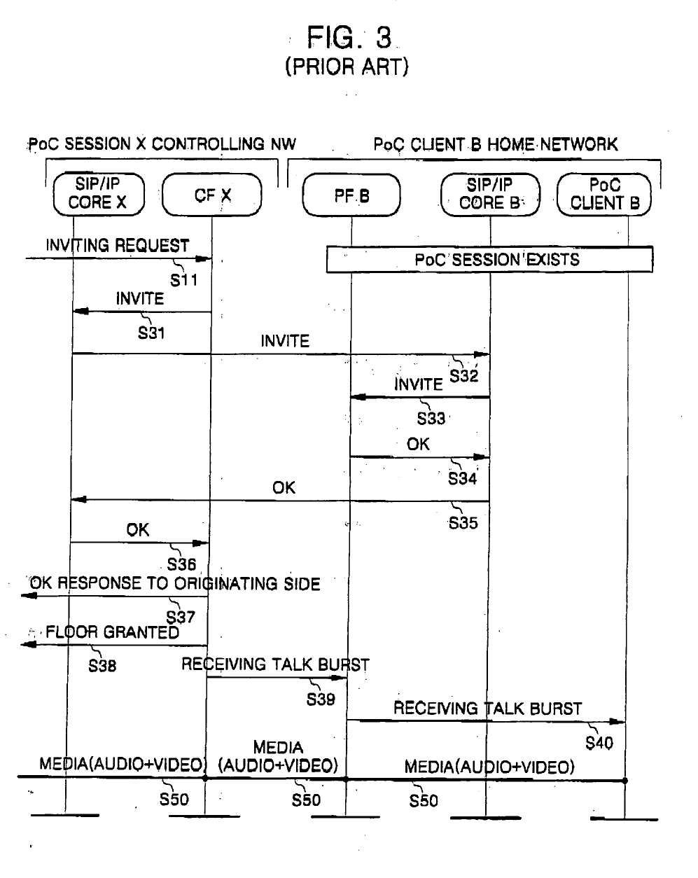

FIG. 4 shows a flow of signals in a process of establishing a group PoC call of an ad-hoc PoC group including expanded group members using a pre-established session according to a first embodiment of the present invention;

FIG. 5 shows a session invitation proxy message (SIP REFER) of an originating PoC client shown in FIG. 4;

FIG. 6 shows a session invitation message (SIP INVITE) of an originating PoC client shown in FIG. 4;

FIG. 7 shows a flow of signals in a process of establishing a group PoC call of an ad-hoc PoC group including expanded group members using a pre-established session according to a second embodiment of the present invention;

FIG. 8 shows a session invitation proxy message (SIP REFER) of an originating PoC client shown in FIG. 7;

FIG. 9 shows a session invitation proxy message (SIP REFER) for session invitation to a terminating PoC server shown in FIG. 7; and

FIG. 10 shows a flow of signals in a process of establishing a group PoC call of an ad-hoc PoC group including expanded group members when an on-demand session is established according to a third embodiment of the present invention.

### DETAILED DESCRIPTION OF THE PREFERRED EMBODIMENTS

Hereinafter, preferred embodiments of the present invention will be described in full detail with reference to the accompanying drawings. For the sake of clarity and conciseness, matters related to the present invention that are well-known among those of skill in the art to which the present invention pertains will not be described herein.

The present invention has a basic structure including an ordinary PoC system, namely a PoC terminal, a PoC server, and sub-networks (a SIP/IP core network, a radio access network, etc.) for interconnecting between the PoC terminal and the PoC server. The PoC terminal includes a PoC client for using PoC services, and the PoC server can act as CF or PF according to whether it owns a group session. This structure is basically the same as the ordinary PoC system, and thus will not be described in detail.

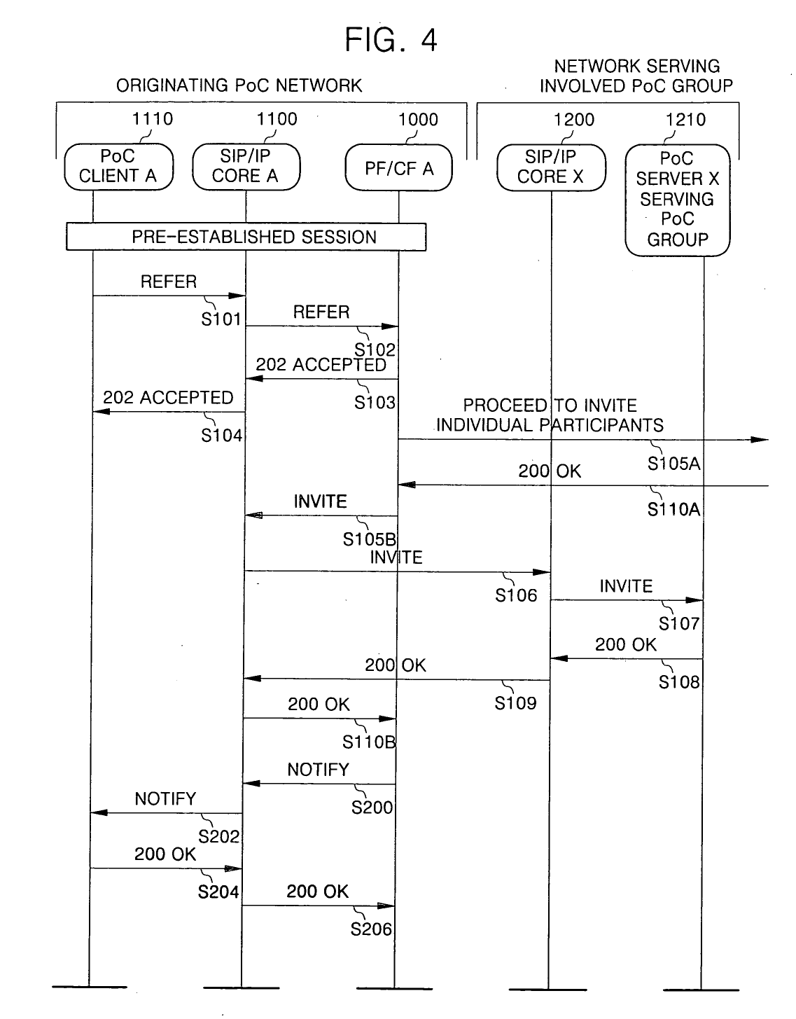

FIG. 4 shows flow of signals in a process of establishing a group PoC call of an ad-hoc PoC group including expanded group members using a pre-established session according to a first embodiment of the present invention.

Referring to FIG. 4, a PoC client A 1110 forwards a REFER message to a corresponding PoC server, a PF/CF A 1000, using session dialog information of a pre-established session (S101 and S102), and receives a 202 Accepted response to the forwarded message (S103 and S104). This means that the PoC client creates no additional session dialog information, and that the PoC client forwards a simpler SIP message to the PoC server via a radio access network because it does not include a Session Description Protocol (SDP) offer used to negotiate media.

The SDP offer is provided to negotiate parameters of the session. In the case of a pre-established session, it is not necessary to negotiate the media and thus not necessary to include the SDP offer.

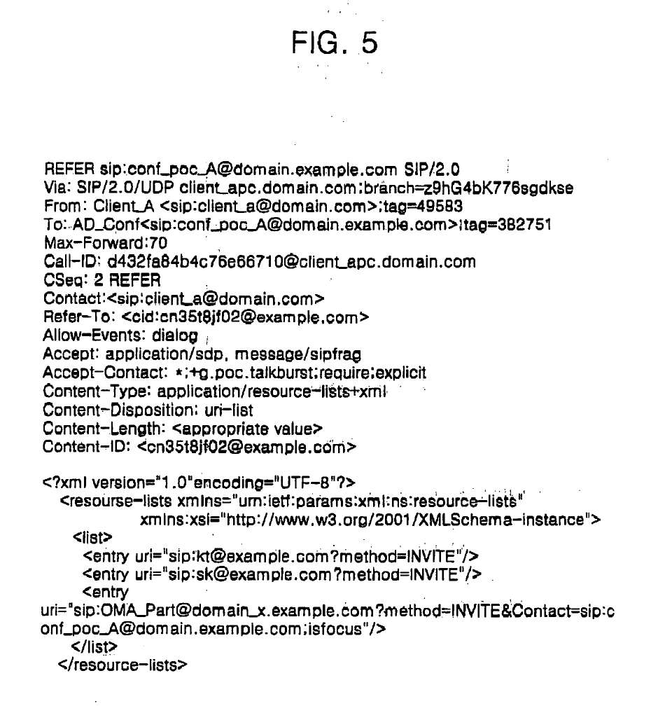

Meanwhile, the REFER message designates many pieces of destination address information known as entry uniform resource identifiers (URIs), and an SIP message method of each destination address, in attached content in the form of an URI list. The URI list can include identities of the pre-arranged group and general PoC group. A format of the REFER message will be described later with reference to FIG. 5.

Next, the PF/CF A 1000 forwards an INVITE message for session invitation to a corresponding individual PoC client and the pre-arranged group which are included in the received REFER message. At this time, a general procedure of establishing an ad-hoc PoC session is performed on each individual PoC client in an INVITE fashion (S105a). The PF/CF A 1000 can indicate that the PF/CF A 1000 becomes the focus of a conference using an option tag “isfocus.” In practice, the information of step S105a is transmitted to an end user through a SIP/IP core A 1100.

Then, a response message is received from each client (S110a). In the same manner as the information of step S105a, the information of step S110a is transmitted from the end user through the SIP/IP core A 1100.

Meanwhile, the INVITE message for the pre-arranged group is requested to the SIP URI of a corresponding group identity. The INVITE message is transmitted to a PoC server 1210 hosting the pre-arranged group through routing of the SIP/IP core A 1110 (S105b, S106 and S107). At this time, the INVITE message includes the option tag “isfocus” for indicating that the PF/CF A 1000 becomes a conference server hosting the ad-hoc session. The PoC server 1210, which hosts the pre-arranged group and receives the INVITE message, receives the option tag “isfocus” in a Contact header part of the INVITE message, thus confirming that the PoC server X 1210 does not become the conference server and forwarding the INVITE message to each constituent client. Thus, the PoC server X 1210 receives each response to the INVITE message from members of the pre-arranged group (S108˜S109), and enables the members of the pre-arranged group to participate in the ad-hoc session.

Meanwhile, the REFER message can implicitly request a NOTIFY message (S200, S202) and obtain event information occurring in the ad-hoc session using the NOTIFY message. If it is determined that the NOTIFY message is not needed, the NOTIFY message can be controlled using an option tag “norefersub.”

FIG. 5 shows a session invitation proxy message (SIP REFER) of an originating PoC client shown in FIG. 4. Referring to FIG. 5, the Request URI “confpocA@domain.example.com” of a REFER message is set as the URI of a pre-established session, which can serve as the identity of an ad-hoc session to be established. The tag field of a From/To header indicates use of the same dialog using information obtained from the conventional pre-established session. Meanwhile, a destination to which a terminating user agent of the REFER, i.e. a PoC server (a PF/CF A 1000 of FIG. 4), should refer is included in a Refer-To header. In the present invention, since many individuals and groups are invited, information on this URI list is included as content in a Multi-purpose Internet Mail Extensions (MIME) portion, and a content identity, Content-ID, for identifying this content is used as a “cid” parameter. As a result, the Refer-To header has “cid:cn35t8jf02@example.com” inserted therein (see the ninth line of FIG. 5). The MIME portion of the message corresponding to the content identity includes both a SIP address of the individual client that corresponds to the target URI of the ad-hoc session and an identity of the pre-arranged group. At this time, the destination address information indicates information on headers of an SIP message and an additional SIP message that a terminating PoC server should take. For example, as in the fifth line of the message provided in FIG. 5, an address “sip:kt@example.com” indicates an address to which the “INVITE” message is transmitted. Further, with regard to transmission of the “INVITE” message to “sip:OMA_Part@domain_x.example.com” for the pre-arranged group, a conference URI of the ad-hoc session is added to the “Contact” header, and an option tag “isfocus” is also attached. When such information is included, a corresponding pre-arranged group recognizes that the PoC server hosting the ad-hoc session becomes a conference server, and sends back a response to the INVITE request.

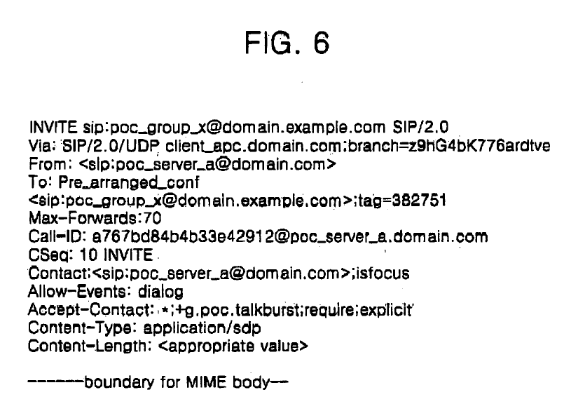

FIG. 6 shows a session invitation message (SIP INVITE) of an originating PoC client shown in FIG. 4. Referring to FIG. 6, the Request URI “pocgroupx@domain.example.com” of an INVITE message is set up as the group URI of a pre-arranged group. The tag field of a “To” header indicates use of the same dialog using information obtained from a conventional pre-established session. Meanwhile, a PF/CF A (1000 of FIG. 4) transmits an INVITE request with an option tag “isfocus” attached to a “Contact” header (see the ninth line of FIG. 6) in order to inform that the PF/CF A becomes the conference server of an established PoC session. By using this information, each client of the corresponding pre-arranged group forwards a session request response to a PoC server hosting the ad-hoc session.

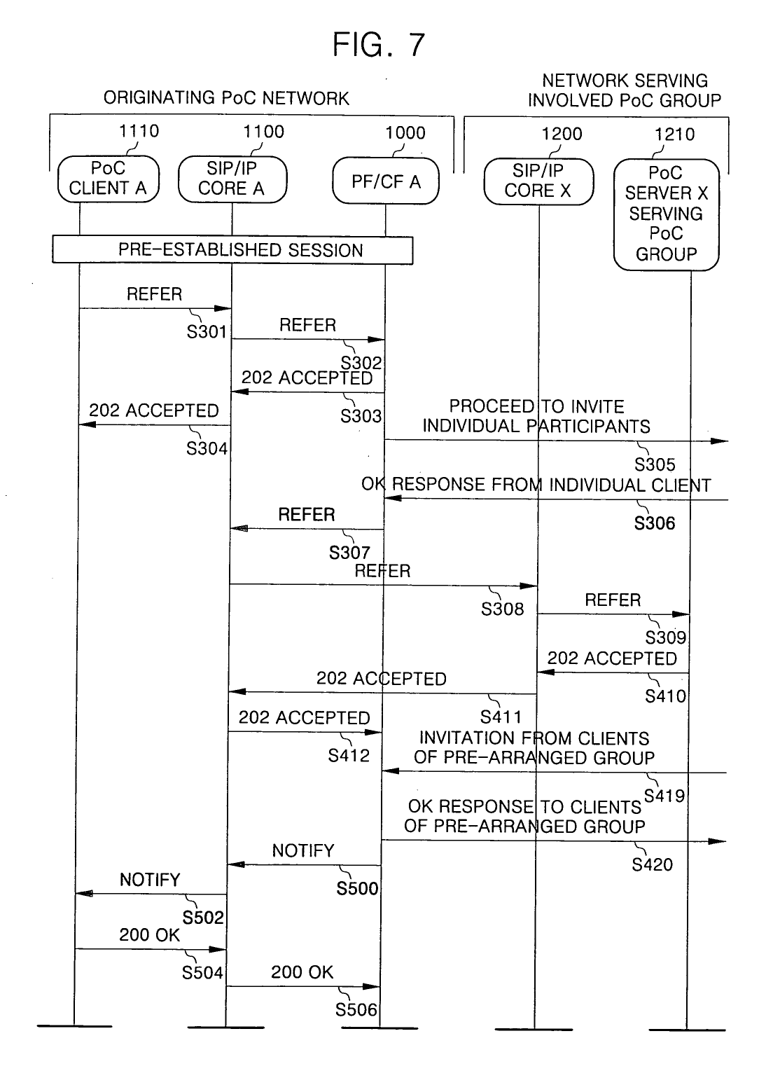

FIG. 7 shows a flow of signals in a process of establishing a group PoC call of an ad-hoc PoC group including expanded group members using a pre-established session according to a second embodiment of the present invention.

Referring to FIG. 7, a PoC client A 1110 desiring to make a PoC call requests a PF/CF A 1000 of its home PoC network to establish an ad-hoc session using a SIP REFER message (S301 and S302). At this time, the SIP REFER message establishes the ad-hoc group session of the same dialog using session information created and stored in the process of a pre-established session initially established in the same manner as in FIG. 4. After receiving the REFER message, the PF/CF A 1000 responds with a 202 Accepted message confirming that the REFER message is successively received (S303 and S304). Here, the 202 Accepted message is a response message confirming receipt of the REFER message regardless of a future process of establishing the ad-hoc session.

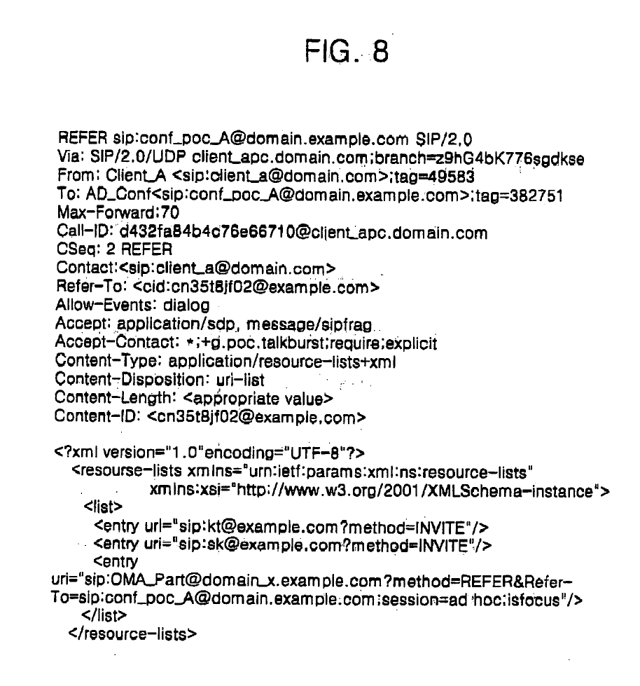

Similar to as shown in FIG. 5, the REFER message designates many pieces of destination address information known as entry uniform resource identifiers (URIs), and an SIP message method of each destination address, in attached content in the form of an URI list. The URI list can include identities of the pre-arranged group and general PoC. A format of the REFER message will be described later with reference to FIG. 8.

Next, the PF/CF A 1000 forwards an SIP message for session invitation to a corresponding individual PoC client and the pre-arranged group included in the received REFER message, along with information on each URI. At this time, a general procedure of establishing the ad-hoc PoC session is performed on each individual PoC client in such a manner that each INVITE message is transmitted to each individual PoC client (S305). The PF/CF A 1000 can indicate that the PF/CF A 1000 becomes the focus of a conference using an option tag “isfocus.” In practice, the information of step S305 is transmitted to an end user through a SIP/IP core A 1100.

Then, a response message is received from each client (S306).

Meanwhile, the REFER message is transmitted to the pre-arranged group according to a method designated in a corresponding URI in an MIME message. Specifically, the REFER message is transmitted to a PoC server 1210 hosting the pre-arranged group through routing of the SIP/IP core A 1110 (S307, S308 and S309). At this time, the internal header field of the REFER message includes the option tag for indicating that the PF/CF A 1000 becomes a conference server hosting the ad-hoc session. The host server 1210 of the pre-arranged group which receives the REFER message transmits the SIP message including the URI information (i.e. the group identity of the ad-hoc session) of the conference server to members of the pre-arranged group, and enables each member of the pre-arranged group to perform dial-in on the ad-hoc session and thus participate in the ad-hoc session (S419).

Meanwhile, the REFER message can implicitly request a NOTIFY message and obtain event information occurring in the ad-hoc session using the NOTIFY message. If it is determined that the NOTIFY message is not needed, the NOTIFY message can be controlled using an option tag “norefersub.”

Thus, when the option tag “norefersub” is not included in the REFER message in steps S301 and S302, the NOTIFY message is transmitted from the PF/CF A 1000 to the originating PoC client A 1110 (S500 and S502). Then, a 200 OK response is transmitted from the originating PoC client A 1110 to the PF/CF A 1000 (S504 and S506).

FIG. 8 shows a session invitation proxy message (SIP REFER) of an originating PoC client shown in FIG. 7. Referring to FIG. 8, the Request URI “confpocA@domain.example.com” of a REFER message is set as a URI allocated when establishing a pre-established session, and can operate as the identity of an ad-hoc session to be established. The tag field of a From/To header indicates use of the same dialog using information obtained from the conventional pre-established session. Meanwhile, a destination to which a terminating user agent of the REFER, i.e. a PoC server (a PF/CF A 1000 of FIG. 7), should refer is included in a Refer-To header. In the present invention, since many individuals and groups are invited, information on this URI list is included as content in an MIME portion, and a content identity, Content-ID, for identifying this content is used as a “cid” parameter. As a result, the Refer-To header has “cid:cn35t8jf02@example.com” inserted therein (see the ninth line of FIG. 8). The MIME portion corresponding to the content identity includes both an SIP address of the individual client that corresponds to the target URI of the ad-hoc session and an identity of the pre-arranged group. At this time, the destination address information, the entry URI, indicates information on headers of an SIP message and an additional SIP message that a terminating PoC server should take. For example, as in the fifth line of the message of FIG. 8, an address “sip:kt@example.com” indicates an address to which the “INVITE” message is transmitted.

Further, with regard to transmission of the “INVITE” message to “sip:OMA_Part@domain_x.example.com” for the pre-arranged group, a conference URI of the ad-hoc session is added to the “Refer-To” header to be included in a new REFER message (in steps S307, S308 and S309), and with respect to this addition a session type parameter “session” and an option tag “isfocus” are also attached. Due to this additional information, a corresponding pre-arranged group recognizes that the PoC server hosting the ad-hoc session becomes the conference server, and with respect to this recognition, each member transmits the INVITE message to participate in the ad-hoc session.

Meanwhile, both the number of individuals corresponding to the target URI of the ad-hoc session and the number of pre-arranged groups are determined according to policy regarding establishment of the corresponding ad-hoc session. Thus, even when the multiple individuals and pre-arranged groups are included within the range, the foregoing method can be equally applied.

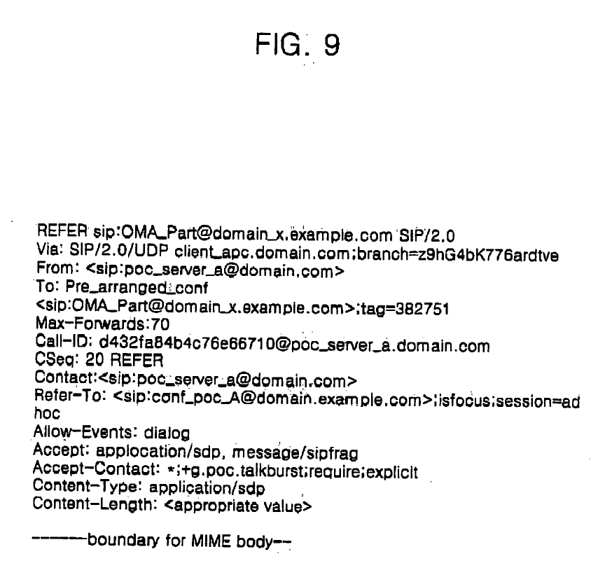

FIG. 9 shows a session invitation proxy message (SIP REFER) for session invitation to a terminating PoC server shown in FIG. 7. Referring to FIG. 9, the Request URI “sip:OMA_Part@domain_x.example.com” of the REFER message that is newly created by REFER is set as a group URI of the pre-arranged group. The tag field of a “To” header indicates use of the same dialog using information obtained from a conventional pre-established session. Meanwhile, a PF/CF A (1000 of FIG. 7) transmits a REFER with an option tag “isfocus” attached to a “Refer-To” header (see the tenth line of FIG. 9) in order to indicate that the PF/CF A becomes the conference server of an established PoC session. Further, the PF/CF A can indicate a type of the established session by including “session=ad hoc” in the “Refer-To” header.

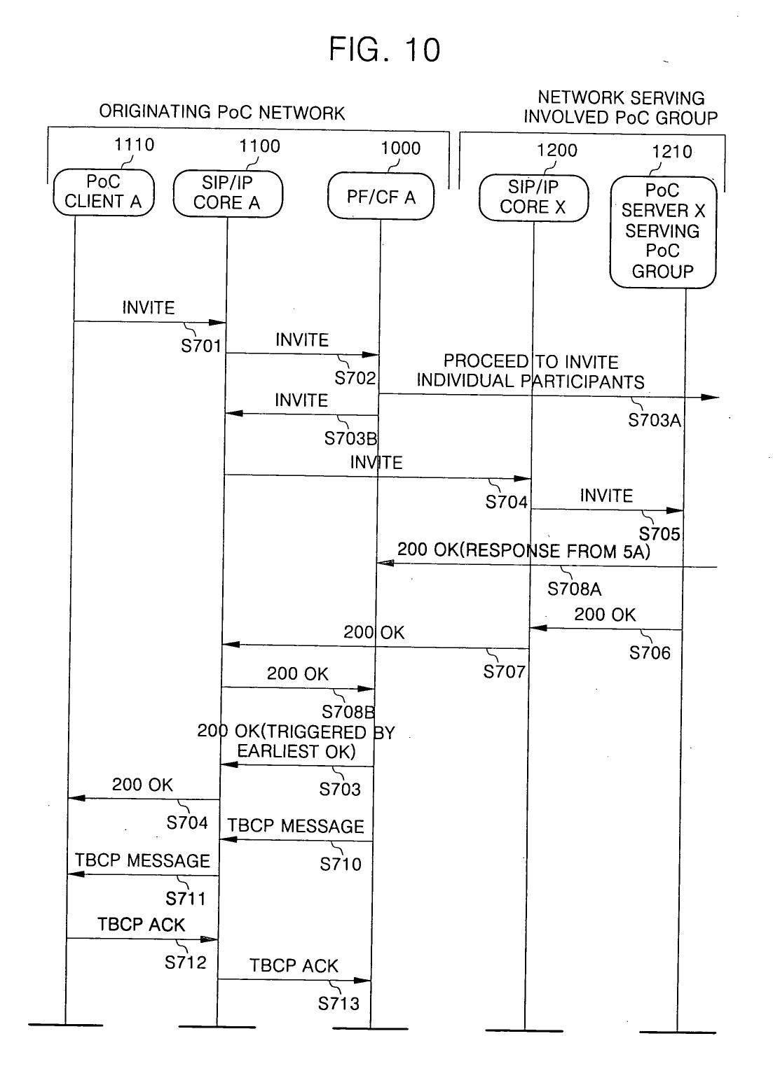

The first and second embodiments are directed to session establishment using a pre-established session. Establishment of an on-demand session according to the present invention can be implemented as shown in FIG. 10.

FIG. 10 shows a flow of signals in a process of establishing a group PoC call of an ad-hoc PoC group including expanded group members when an on-demand session is established according to a third embodiment of the present invention.

Referring to FIG. 10, an INVITE message of steps S701 and S702 includes both an individual PoC address and a group identity. Thus, a PF/CF A 1000 transmits INVITE including an option tag “isfocus” to the corresponding PoC server of an assigned PoC group (S703b, S704 and S705). Thereby, a session can be established.

At this time, a general procedure of establishing an ad-hoc PoC session is performed on each individual client in an INVITE fashion (S703a). The PF/CF A 1000 can indicate that the PF/CF A 1000 becomes the focus of a conference using the option tag “isfocus.” In practice, the information of step S703a is transmitted to an end user through an SIP/IP core A 1100.

Meanwhile, the INVITE message for a pre-arranged group is requested to the SIP URI of a corresponding group identity. The INVITE message is transmitted to a PoC server 1210 hosting the pre-arranged group through routing of the SIP/IP core A 1110 (S703b, S704 and S705). At this time, the INVITE message includes the option tag for indicating that the PF/CF A 1000 becomes a conference server hosting the ad-hoc session. The PoC server X 1210, which hosts the pre-arranged group and receives the INVITE message, receives the option tag “isfocus” in a Contact header part of the INVITE message, thus confirming that the PoC server X 1210 does not become the conference server and forwarding the INVITE message to each constituent client. Thus, the PoC server X 1210 receives each response to the INVITE message from members of the pre-arranged group (S708a, S708b, S703 and S704), and enables the members of the pre-arranged group to participate in the ad-hoc session.

Then, a talk burst control signal is exchanged using Talk Burst Control Protocol (TBCP), and then media is transmitted (S710, S711, S712 and S713).

Meanwhile, in the first to third embodiments, both the number of individuals corresponding to the target URI of the ad-hoc session and the number of pre-arranged groups are determined according policy regarding the establishment of the corresponding ad-hoc session. Thus, even when the multiple individuals and pre-arranged groups are included within the range, the foregoing method can be equally applied.

The above-described embodiments of the present invention enable flexible establishment of the ad-hoc PoC group talk by causing the PoC client to use the pre-established or on-demand session, and by including the PoC groups arranged by the PoC client in advance, and the numerous PoC users designated in one terminating URI list. The present invention also enhances user convenience and communication performance in the wireless network by transmitting the single SIP message for session establishment.

Although exemplary embodiments of the present invention have been described with reference to the attached drawings, the present invention is not limited to these embodiments, and it should be appreciated by those skilled in the art that a variety of modifications and changes can be made without departing from the spirit and scope of the present invention.

What is claimed is:

1. A system for establishing an ad-hoc session in a push-to-talk-over-cellular (PoC) network, the system comprising:
an originating PoC system in which an originating PoC client transmits a session invitation proxy message including session dialog information, entry uniform resource identifiers (URIs), and a Session Initiation Protocol (SIP) message method, to an originating PoC server in a state in which a pre-established or on-demand session is arranged between the originating PoC client and the originating PoC server;
arbitrary individual PoC clients with which the originating PoC server intends to establish the ad-hoc session; and
an arbitrary PoC group system with which the originating PoC server intends to establish the ad-hoc session.

2. The system according to claim 1, wherein the entry URIs have entries, and when one of the entries is an individual PoC user, a destination address and the SIP message method are designated in an entry URI field.

3. The system according to claim 1, wherein the entry URIs have entries, and when one of the entries is a PoC group, a destination group identity, the SIP message method and an identity of a server hosing the session are designated in an entry URI field.

4. The system according to claim 3, wherein the identity of the server hosting the session is designated by using an option tag “isfocus”.

5. The system according to claim 1, wherein the SIP message method included in the session invitation proxy message is an INVITE or a REFER message.

6. The system according to claim 5, wherein, when the SIP message method included in the session invitation proxy message is an INVITE, the server hosting the session directly performs dial-out on the individual PoC user or the PoC group.

7. The system according to claim 5, wherein, when the SIP message method included in the session invitation proxy message is a REFER, the message is transmitted from the server hosting the session to the PoC group including the dialog information, the identity of the server hosting the session, and information on a group type of the session.

8. The system according to claim 7, wherein, when the REFER of the SIP message method is transmitted, a dial-in from the PoC group for requesting session connection to the server hosting the session is performed.

9. The system according to claim 1, wherein the session invitation proxy message transmitted to the originating PoC server implicitly requests a NOTIFY message indicating event information occurring in the ad-hoc session.

10. The system according to claim 1, wherein the session invitation proxy message transmitted to the originating PoC server controls generation of the NOTIFY message using an option tag “norefersub.”

11. A system for establishing an ad-hoc session in a push-to-talk-over-cellular (PoC) network, the system comprising:
an originating PoC system in which an originating PoC client transmits a session invitation proxy message that includes session dialog information, entry uniform resource identifiers (URIs), and a Session Initiation Protocol (SIP) message method, to an originating PoC server after session establishment using a session establishment request message exchanged between the originating PoC client and the originating PoC server;
arbitrary individual PoC clients with which the originating PoC server intends to establish the ad-hoc session; and
an arbitrary PoC group system with which the originating PoC server intends to establish the ad-hoc session.

12. A method for establishing an ad-hoc session using a pre-established session in a push-to-talk-over-cellular (PoC) network, the method comprising the steps of:
transmitting a session invitation proxy message including session dialog information, entry uniform resource identifiers (URIs), and a Session Initiation Protocol (SIP) message method, to an originating PoC server in a state in which the pre-established session is established;
transmitting, by the originating PoC server, a message based on the SIP message method to a destination address included in the session invitation proxy message; and
establishing the ad-hoc session between an originating PoC system and the destination address included in the session invitation proxy message.

13. The method according to claim 12, wherein the entry URIs are targeted at an individual PoC user or a PoC group.

14. The method according to claim 13, wherein the entry URIs have entries, and when one of the entries is an individual PoC user, a destination address and the SIP message method are designated in an entry URI field.

15. The method according to claim 13, wherein the entry URIs have entries, and when one of the entries is a PoC group, a destination group identity, the SIP message method and an identity of a server hosting the session are designated in an entry URI field.

16. The method according to claim 15, wherein the identity of the server hosting the session is designated by using an option tag “isfocus.”

17. The method according to claim 12, wherein the SIP message method included in the session invitation proxy message is an INVITE or a REFER message.

18. The method according to claim 17, wherein when the SIP message method included in the session invitation proxy message is an INVITE, the server hosting the session directly performs dial-out on the individual PoC user or the PoC group.

19. The method according to claim 17, wherein, when the SIP message method included in the session invitation proxy message is a REFER, the message is transmitted from the server hosting the session to the PoC group including the dialog information, the identity of the server hosting the session, and information on a group type of the session.

20. The method according to claim 19, wherein after the REFER of the SIP message method is transmitted, a dial-in from the PoC group for requesting session connection to the server hosting the session is performed.

21. The method according to claim 12, wherein the session invitation proxy message transmitted to the originating PoC server implicitly requests a NOTIFY message indicating event information occurring in the ad-hoc session.

22. The method according to claim 21, wherein the session invitation proxy message transmitted to the originating PoC server controls generation of the NOTIFY message using an option tag “norefersub.”

23. A method for establishing an ad-hoc session in a push-to-talk-over-cellular (PoC) network, the method comprising the steps of:
performing session establishment between a server hosting the session and a client intending to establish the ad-hoc session;
transmitting a session request message with reference to session dialog information, entry uniform resource identifiers (URIs), and a Session Initiation Protocol (SIP) message method which are arranged when performing session establishment; and
establishing the ad-hoc session between an originating PoC system and the destination address included in the session request message.

24. The method according to claim 23, wherein the entry URIs are targeted at an individual PoC user or a PoC group.

25. The method according to claim 24, wherein the entry URIs have entries, and when one of the entries is an individual PoC user, a destination address and the SIP message method are designated in an entry URI field.

26. The method according to claim 24, wherein the entry URIs have entries, and when one of the entries is a PoC group, a destination group identity, the SIP message method and an identity of a server hosting the session are designated in an entry URI field.

27. The method according to claim 26, wherein the identity of the server hosting the session is designated by using an option tag “isfocus.”

28. The method according to claim 23, wherein the SIP message method included in the session invitation proxy message is an INVITE or a REFER message.

29. The method according to claim 23, wherein the session request message transmitted to the originating PoC server implicitly requests a 200 OK response signal of event information occurring in the ad-hoc session.

30. The method according to claim 29, wherein the response signal is received from an arbitrary client or group, and the ad-hoc session is immediately established.

31. A push-to-talk-over-cellular (PoC) client for establishing an ad-hoc session in a PoC network, wherein:
when a pre-established session is established, a session invitation proxy message including session dialog information, entry uniform resource identifiers (URIs), and a Session Initiation Protocol (SIP) message method is transmitted to an originating PoC server;
a session request message is directly transmitted to an individual PoC user among entries of the entry URIs included in the session invitation proxy message; and
a message including a destination group identity, the SIP message method, an identity of a server hosting the session and an indication informing whether to act as a host of a conference, is transmitted to a PoC group among the entries of the entry URIs.

32. The PoC client according to claim 31, wherein the PoC group among the entries of the entry URIs uses an option tag “isfocus” to designate the identity of the server hosing the session.

33. The PoC client according to claim 31, wherein the SIP message method included in the session invitation proxy message is an INVITE or a REFER message.

34. The PoC client according to claim 33, wherein, when the SIP message method included in the session invitation proxy message is an INVITE, the server hosting the session directly performs dial-out on the individual PoC user or the PoC group.

35. The PoC client according to claim 33, wherein, when the SIP message method included in the session invitation proxy message is a REFER, the message is transmitted from the server hosting the session to the PoC group including the dialog information, the identity of the server hosting the session, and information on a group type of the session.

36. The PoC client according to claim 35, wherein after the REFER of the SIP message method is transmitted, a dial-in from the PoC group for requesting session connection to the server hosting the session is performed.

37. The PoC client according to claim 31, wherein the session invitation proxy message transmitted to the originating PoC server implicitly requests a NOTIFY message indicating event information occurring in the ad-hoc session.

38. The PoC client according to claim 37, wherein the session invitation proxy message transmitted to the originating PoC server controls generation of the NOTIFY message using an option tag “norefersub.”
